(19) United States
(12) Patent Application Publication
(10) Pub. No.: US 2003/0131680 A1
(43) Pub. Date: Jul. 17, 2003

(54) Push/pull cable adapter

(75) Inventors: Haibo Tong, Palatine, IL (US); Marianne Krbec, Elmhurst, IL (US)

Correspondence Address: JAMES RAY & ASSOCIATES, 2640 PITCAIRN ROAD, MONROEVILLE, PA, 15146, US

(73) Assignee: WESTINGHOUSE AIR BRAKE TECHNOLOGIES CORPORATION

(21) Appl. No.: 10/053,167

(22) Filed: Jan. 15, 2002

(51) Int. Cl. F16C 1/10

(52) U.S. Cl. 74/502.4

(57) ABSTRACT

A cable adapter for reducing the available actuation length of the mechanical push-pull type control cable assembly and more particularly of the conduit and cable assembly type. The adapter is inserted between the end of the cable conduit and conduit fitting thus increasing the conduit length and subsequently decreasing cable actuation length.

### FIELD OF THE INVENTION

The present invention relates, in general, to a mechanical push-pull type cable used to control a remotely placed device and, more particularly, this invention relates to a manual release mechanism for manually releasing a door panel on a rail transit vehicle from its closed and locked position and, still more particularly, this invention relates to a cable adapter for use with a manual type release mechanism mounted remotely from such door panel and mounted remotely from the door operator driving the door panel within the confines of the vehicle structure.

### BACKGROUND OF THE INVENTION

Prior to the development of the present invention, mechanical push-pull type cable assemblies were generally well known. They provide a means for manual control of the remotely placed devices. These push/pull cable assemblies generally consist of a cable enclosed within the conduit and terminated by an end fitting at each end.

The conduit is terminated by conduit fittings at each end with each fitting having a means for mounting to the controlled and controlling devices. The ends of the cable generally extend past the conduit fittings for attachment to the receiving cavities in the controlled and controlling devices. The cable extension provides for actuation of the control device and is generally designated at the actuation cable length.

Furthermore, it is generally preferred to completely encase the cable inside the conduit between each conduit fitting to prevent cable damage due to the external environment. Examples of such cable assemblies generally include a throttle cable of the conventional lawn mower, a brake cable of the automobile and a cable for manual opening of the door panel in the mass transit vehicle by means of manually releasing a lock mechanism of a powered door operator. The use of it in conjunction with the present invention will be explained as used in a particular application within a mass transit vehicle.

These assemblies are generally located overhead of the door panel, or in the vertical side wall of the vehicle structure, and generally employ a cable assembly that connects such manual release assembly to the door operator driving such door panel. Special arrangements are provided internal of a door operator and internal of a manual release assembly for attaching such cable assembly.

Furthermore, the cable assembly is substantially attached to various members of the vehicle structure throughout its length with the use of cable clamps. The attachment is necessary to provide uniformity of cable assembly operation and to prevent displacement within the vehicle structure. Prior to the development of the present invention, the determination of the overall cable assembly length and, more particularly, determination of the actuation length is generally a trial and error method due to the design of the vehicle structure and constraints imposed on the cable assembly routing within said vehicle structure.

Typically a case may arise wherein the length of the exposed cable portion is substantially larger than required by the design. Such condition would create exposure of the cable to the environment with potential risk of damage due to the vehicle vibration and cable chafing against the vehicle structure or device itself. It has been known to modify the length of the cable assembly upon initial installation due to the variation of both the vehicle structure and cable assembly routing exceeding the range of the adjustments which exist within the cable assembly design.

It has also been known to implement these modifications after significant quantities of the cable assemblies have been installed within the vehicle structures. Generally these modifications require the procurement of the new cable assemblies and disposal of the previous design.

### SUMMARY OF THE INVENTION

The present invention provides a cable adapter for reducing the actuation length of a push/pull type cable assembly. Such cable adapter comprising a locating portion having an inner cavity with such locating portion used for insertion into a conduit fitting of the cable assembly. A receiving portion having an inner cavity is substantially concentric to the locating portion. A longitudinal slot extends the entire length of the cable adapter to allow the cable adapter to be placed over the cable portion of the cable assembly with such cable assembly further encased by both inner cavities after installation.

### OBJECTS OF THE INVENTION

Therefore, it is one of the primary objects of the present invention to provide a cable adapter which can compensate for extra cable length.

It is an additional object of the present invention to provide a cable adapter having simplified means of installation.

It is a further object of the present invention to provide a cable adapter which will substantially eliminate the need for cable replacement

It is another object of the present invention to provide a cable adapter which substantially minimizes cable exposure to the environment during vehicle motion and/or a manual release operation.

These and various other objects and advantages to the present invention will become more readily apparent to those persons skilled in the relevant art from the following more detailed description, particularly, when such description is taken in conjunction with the attached drawing figures and with the appended claims.

### BRIEF DESCRIPTION OF THE DRAWINGS

FIG. 1 is a partial perspective view of a typical transit car body, particularly, showing a location of the door operators, manual release assembly and manual release cable assembly;

FIG. 2 is a perspective view of the invention illustrated in FIG. 1 particularly showing the location of the components internal to the cable assembly and its attachment to the door operator and manual release assembly and showing application of the cable adapter;

FIG. 3 is a perspective view of the end fitting of the manual release cable assembly in FIG. 2, showing its detail design and construction;

FIG. 4 is a perspective view of the cable adapter in FIG. 2 showing its detail design and construction; and

FIG. 5 is a perspective view of the alternative design of the cable adapter in FIG. 4 showing details of the internal and external threads.

### DESCRIPTION OF VARIOUS EMBODIMENTS OF THE INVENTION

Prior to proceeding to the more detailed description of the instant invention, it should be noted that identical components which have identical functions have been identified with identical reference numerals throughout the several views illustrated in the drawing figures for the sake and clarity in understanding the invention.

The invention disclosed herein overcomes cable assembly application difficulties through the use of a manual release cable adapter device which reduces the actuation length without the need to procure new cable assemblies. Also, a part of the invention disclosed herein is an economic means of reducing the actuation length without the need to replace cable assemblies already installed within the vehicle structure. The design, therefore, provides the advantage of reduced project costs.

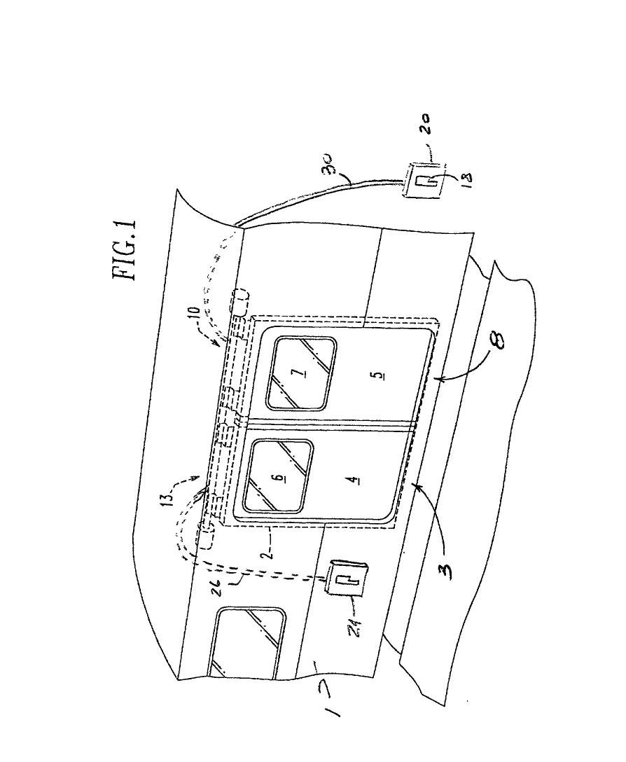

With respect to FIG. 1, there is shown a partial view of a “typical” transit vehicle 1 having a door opening 2. It has a power door, generally designated 3, consisting of door panel 4 driven by a door operator 13 and having a window 6. It also has a power door, generally designated 8, consisting of door panel 5 driven by a door operator 10 and having a window 7. Bi-parting doors 4 and 5 are for reciprocal motion over and away from the opening 2 in such transit vehicle 1.

Mounted overhead of door panels 4 and 5, the operators 10 and 13 provide the above-mentioned powered reciprocal motion. A manual release assembly 20 is mounted adjacent the door panel 5 and connects to such door operator 10 with cable assembly 30. Furthermore, a manual release assembly 24 is mounted adjacent the door panel 4 and connects to door operator 13 with cable assembly 26. The assemblies 20 and 24 provide means for manual reciprocal motion of door panels 4 and 5.

Alternatively such manual release mechanisms 20 and 24 may be mounted overhead or underneath of the opening 2. As manual release mechanisms 20 and 24 are identical, the following description will be concerned with manual release 20 as those skilled in the art will readily understand that operation of manual release mechanism 24 is identical other than the direction of motion.

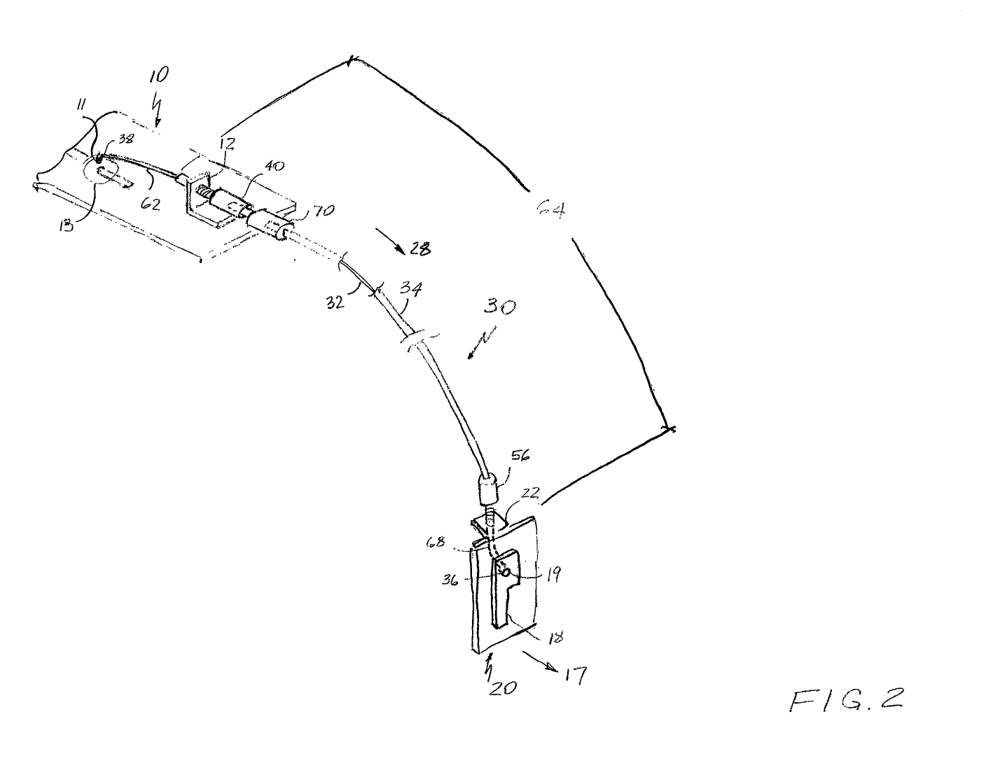

In the presently preferred embodiment, according to FIG. 2, cable assembly 30 is mounted to mounting member 22 of the manual release 20 and is attached to such cable mounting cavity 19 internal of pull handle 18 at one end. The distal end of the cable assembly 30 is mounted to mounting member 12 internal of door operator 10 and is attached to lock mechanism cavity 11 internal of door operator 10.

As further shown in FIG. 2 the cable assembly 30 includes conduit 34 having an internal cavity (not shown) of a predetermined diameter D. Furthermore, such cable assembly 30 has a conduit fitting 40 at one end for attachment to door operator mounting member 12 and a conduit fitting 56 at its distal end for attachment to mounting member 22 of manual release assembly 20. Cable 32 is substantially enclosed within the cavity and is terminated by cable fitting 38 and by cable fitting 36. The cable fitting 38 is generally selected to engage into specific cavity 11 within door operator 10. Accordingly, such cable fitting 36 is generally selected to engage into specific cavity 19 within manual release assembly 20. As conduit fittings 40 and 56 are identical, the following description will be concerned with fitting 40 as those skilled in the art will readily understand that operation of the conduit fitting 56 is identical other than the direction in the cable assembly 30. Generally, the cable assembly 30 has a fixed control portion designated 64 and cable actuation portions 62 extending past the end of conduit fitting 40 and actuating portion 68 extending past conduit fitting 56. In further reference to FIG. 2 a cable adapter 70 is attached to the conduit fitting 40 encasing conduit 34.

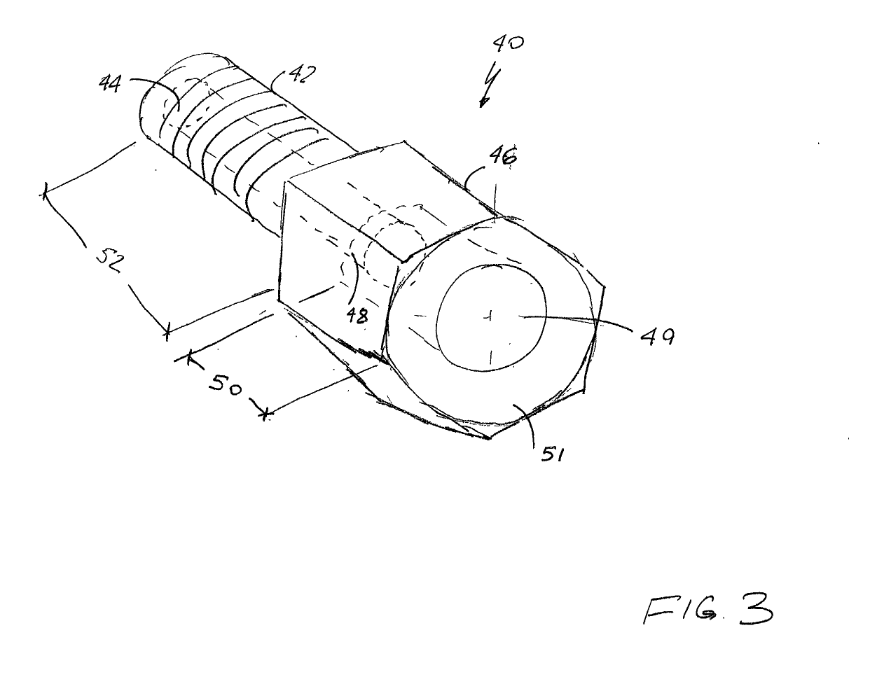

In reference to FIG. 3 conduit fitting 40 includes a threaded portion 42 and a housing portion 41. The threaded portion 42 having an overall length 52 includes an internal cavity 44. Threaded portion 42 is provided for engagement onto mounting member 12 internal of door operator 10 allowing change of the position of such conduit fitting 40 in relationship to the cavity 11 internal of door operator 10. Housing portion 46 includes an internal cavity, generally designated 49, having a depth 50 and disposed substantially concentric with internal cavity 44. The internal cavity 49 is open on one end and has a bottom wall 48 adjacent the threaded portion 42. Such bottom wall 48 is provided for stopping against conduit 34 generally disposed within cavity 44 during installation.

Furthermore, it is preferred that cavity 49 of such conduit fitting 40 slides over a predetermined outer diameter D of conduit 34 with minimal clearance between the cavity 49 and the outer diameter D of conduit 34.

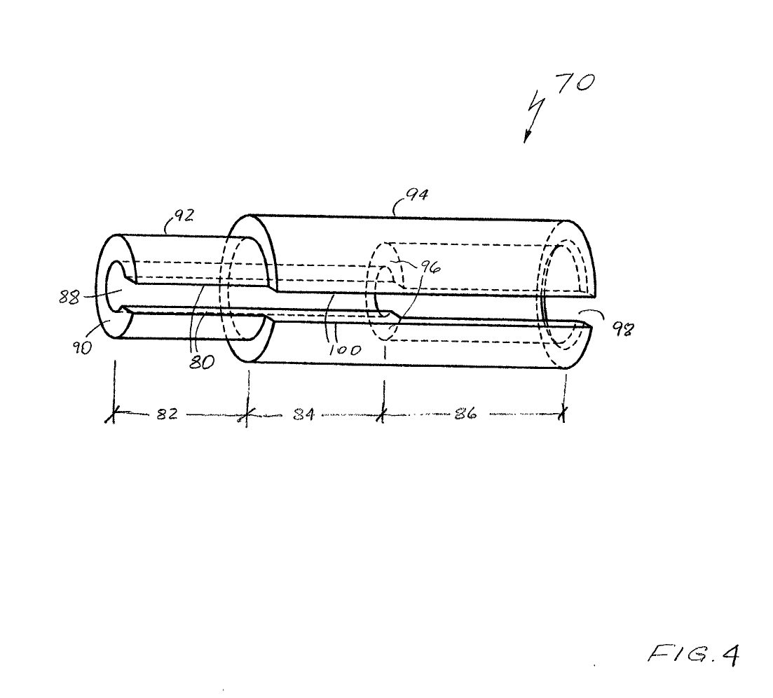

The detail design of the cable adapter 70 is illustrated in FIG. 4. It illustrates that such cable adapter 70 includes a locating portion 92 and a receiving portion 94 substantially concentric to such locating portion 92. Furthermore, cable adapter 70 includes a longitudinal slot 80 and a longitudinal slot 100 substantially parallel and linear to such slot 80. Locating portion 92, having an overall length 82, includes a semi-cylindrical internal cavity 88. Such locating portion 92 also includes an end surface 90 substantially perpendicular to internal cavity 88. The receiving portion 94 includes a semi-cylindrical internal cavity 98 having an overall length 86. Such cavity 98 is open on one end and has a bottom wall 96 adjacent such cavity 88. The combination of the predetermined length 82 and the predetermined length 84 increase the predetermined fixed length 64 within such cable assembly 30 and decrease the predetermined actuation length 62.

During manual operation, in reference to FIG. 2, a pull of the handle 18 in the direction 17 moves cable 32 in the direction 28 with subsequent displacement of the locking mechanism 13 and movement of door panel 5 away from the center of door opening 2.

As the distance between mounting member 12 and cavity 11 has been predetermined and fixed, the extra length of cable 32 will form a gap between outer surface 51 internal to conduit fitting 40 and the conduit end (not shown), exposing cable 32 to vehicle structure and increasing the risk of such cable 32 damage.

In the preferred embodiment the cable adapter 70 is placed between the conduit fitting 40 and the conduit end (not shown). The adapter 70 is positioned so that slots 80 and 100 fit over cable assembly 32 and locating portion 92 is encased within the cavity 49 of such conduit fitting 40 with surface 90 of the adapter 70 substantially engaging the bottom wall 48 of such fitting 40. Furthermore, the receiving portion 94 encases conduit 34 with bottom wall 96 of such adapter 70 placed substantially engaging the conduit end (not shown). Additionally, cable 32 is encased within internal cavity 88 of such adapter 70.

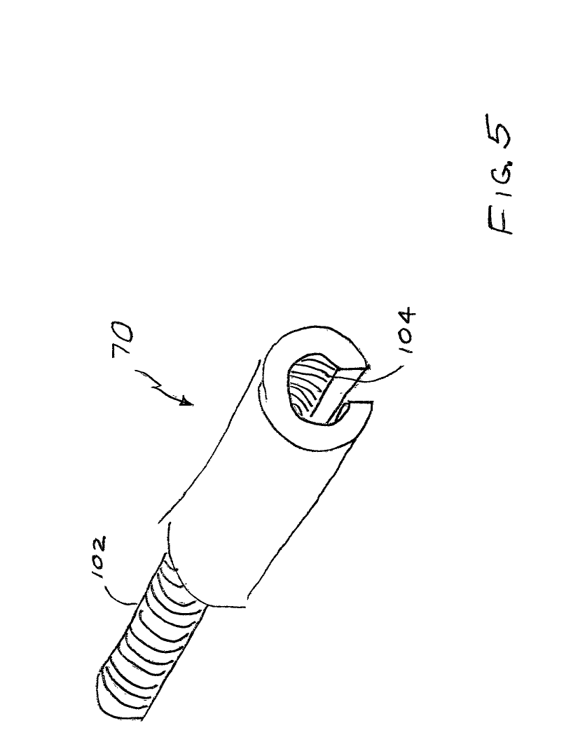

Alternatively, in reference to FIG. 5, a modified configuration of the cable adapter 70 having threaded cavity 104 and threaded portion 102 identical to threaded portion 42 of the conduit fitting 40 can be attached to the threaded portion 42 of such conduit fitting 40 when this conduit fitting 40 is permanently attached to conduit 34.

Although a presently preferred and various alternative embodiments of the cable adapter have been described in considerable detail above with particular reference to the drawing FIGURES, it should be understood that various additional modifications and/or adaptations of the present invention can be made and/or envisioned by those persons skilled in the relevant art without departing from either the spirit of the instant invention or the scope of the appended claims.

We claim:

1. A cable adapter for reducing an actuation length of a push/pull type cable assembly, said adapter assembly comprising:
(a) a locating portion having an inner cavity;
(b) a receiving portion disposed substantially concentric to said locating portion and having an inner cavity; and
(c) a longitudinal slot extending substantially along an entire length of said cable adapter between an outer surface thereof and a surface of said inner cavity of each of said locating portion and said receiving portion.

2. A cable adapter, according to claim 1, wherein a predetermined diameter D of said locating portion is substantially equal to an inner cavity diameter of a conduit fitting.

3. A cable adapter, according to claim 1, wherein a predetermined diameter D of said inner cavity of said receiving portion is substantially equal to an outer diameter of such conduit.

4. A cable adapter, according to claim 1, wherein said locating portion of said adapter includes a threaded portion on at least one of an outer surface thereof and a surface of said inner cavity.

5. A cable adapter, according to claim 4, wherein said receiving portion of said adapter includes a threaded portion on at least one of an outer surface thereof and a surface of said inner cavity.

6. A cable adapter, according to claim 1, wherein said longitudinal slot extends along an entire length of said cable adapter between an outer surface thereof and a surface of said inner cavity of each of said locating portion and said receiving portion.

7. A cable adapter, according to claim 6, wherein said locating portion of said adapter includes a threaded portion on an outer surface thereof.

8. A cable adapter, according to claim 7, wherein said receiving portion of said adapter includes a threaded portion on a surface of said inner cavity.

9. In combination with a transit vehicle door operating system, the improvement comprising a cable adapter assembly for reducing an actuation length of a push/pull type cable assembly, said adapter assembly including;
(a) a locating portion having an inner cavity,
(b) a receiving portion disposed substantially concentric to said locating portion and having an inner cavity, and
(c) a longitudinal slot extending substantially along an entire length of said cable adapter between an outer surface thereof and a surface of said inner cavity of each of said locating portion and said receiving portion.

10. The combination, according to claim 9, wherein a predetermined diameter D of said locating portion is substantially equal to an inner cavity diameter of a conduit fitting.

11. The combination, according to claim 9, wherein a predetermined diameter D of said inner cavity of said receiving portion is substantially equal to an outer diameter of such conduit.

12. The combination, according to claim 1, wherein said locating portion of said adapter includes a threaded portion on at least one of an outer surface thereof and a surface of said inner cavity.

13. The combination, according to claim 12, wherein said receiving portion of said adapter includes a threaded portion on at least one of an outer surface thereof and a surface of said inner cavity.

14. The combination, according to claim 9, wherein said longitudinal slot extends along an entire length of said cable adapter between an outer surface thereof and a surface of said inner cavity of each of said locating portion and said receiving portion.

15. The combination, according to claim 14, wherein said locating portion of said adapter includes a threaded portion on an outer surface thereof.

16. The combination, according to claim 15, herein said receiving portion of said adapter includes a threaded portion on a surface of said inner cavity.
